(19) United States
(12) Patent Application Publication
(10) Pub. No.: US 2007/0285402 A1
(43) Pub. Date: Dec. 13, 2007

(54) MOBILE TERMINAL AND METHOD OF DISPLAYING IMAGE THEREOF

(75) Inventors: Sang Yeon Lim, Gyeonggi-do (KR); Yeon Woo Park, Seoul (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG ELECTRONICS INC.

(21) Appl. No.: 11/758,145

(22) Filed: Jun. 5, 2007

(30) Foreign Application Priority Data
Jun. 8, 2006 (KR) 102006-0051442

(51) Int. Cl. G06F 3/041

(52) U.S. Cl. 345/173

(57) ABSTRACT

A method for providing light feedback responsive to user contact with an input device includes receiving user contact at an input area associated with a touchpad that includes a plurality of regions, and identifying which region of the touchpad is associated with the user contact. The method further includes navigating items displayed on an associated display, which is separate from the input area, responsive to the user contact, and generating light responsive to the user contact from at least one light emitting device at a location proximately located to the user contact.

### CROSS-REFERENCE TO RELATED APPLICATIONS

Pursuant to 35 U.S.C. §119(a), this application claims the benefit of earlier filing date and right of priority to Korean Application No. 10-2006-0051442, filed on Jun. 8, 2006, the contents of which are hereby incorporated by reference herein in their entirety.

### BACKGROUND OF THE INVENTION

1. Field of the Invention

The present invention relates generally to a portable electronic device, and in particular to providing light feedback responsive to user contact with a touchpad associated with such an electronic device.

2. Discussion of the Related Art

A mobile terminal is one type of portable electronic device. A typical mobile terminal includes a display, such as a liquid crystal display (LCD), for displaying various types of data including, for example, call related data, a menu list, a menu execution image, photos, graphics, and the like. More recently, mobile terminals are being configured to receive and display broadcast content. Such mobile terminals have increased power requirements for displaying broadcast programs.

Mobile terminals commonly include a navigation key (e.g., multi-key, direction key, etc.) which permits user control of the terminal via an associated display. The size of the navigation keys has increased to accommodate additional functionality. Some navigation keys are implemented in conjunction with a touchpad. A drawback of such arrangements is that since the user is not required to press a button, there is a noticeable lack of feedback to the user. Accordingly, it is difficult for the user to discern whether the desired input has been detected by the mobile terminal.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

In accordance with an embodiment, a method for providing light feedback responsive to user contact with an input device includes receiving user contact at an input area associated with a touchpad that includes a plurality of regions, and identifying which region of the touchpad is associated with the user contact. The method further includes navigating items displayed on an associated display, which is separate from the input area, responsive to the user contact, and generating light responsive to the user contact from at least one light emitting device at a location proximately located to the user contact.

According to one feature, on of the regions defines a navigational direction key region, such that the method further includes navigating the items responsive to user contact with the navigational direction key region or includes selecting one of the items responsive to user contact with the navigational key region.

According to another feature, the method further includes providing tactile feedback responsive to user contact with the selection or navigational key region.

According to another feature, the method further includes receiving sliding user contact at the input area, and generating light responsive to the sliding user contact from a plurality of light emitting devices which are each proximately located to the user contact, such that the light emitting devices are arranged as a two-dimensional array within the input area.

According to yet another feature, the method further includes determining that the user contact has not occurred for a predetermined period of time, and entering an idle mode until additional user contact is received, such that the idle mode includes generating light from a light emitting device located within the input area and repeatedly modifying perceived brightness of the light over a period of time during the idle mode.

According to still yet another feature, after entering an idle mode, the method further includes generating light from a predetermined number of light emitting devices located within the input area, and repeatedly modifying the predetermined number over a period of time during the idle mode.

According to one aspect, the method further includes determining an occurrence of an event, and displaying (or animating) an icon representing the event using a plurality of light emitting devices. If desired, after the displaying, the method further includes receiving additional user contact at the input area, and causing an application associated with an event to execute responsive to the additional user contact.

According to yet another aspect, the method further includes simultaneously receiving user contact on at least two discrete locations of the input area, identifying that the user contact corresponds to at least two regions of the plurality of regions to define a selection request, and selecting an identified item of the items responsive to the selection request.

According to still yet another aspect, the method further includes providing tactile feedback responsive to the selection request.

According to one feature, the method further includes causing an event to occur at the mobile terminal responsive to the user contact, and displaying an icon representing the event using a plurality of light emitting devices.

According to another feature, the method further includes outputting audio of an audio signal, and displaying an image corresponding to the audio signal using a plurality of light emitting devices. If desired, the image includes one or more of the strength of the audio signal as a function of frequency, and an animated equalizer image.

These and other embodiments will also become readily apparent to those skilled in the art from the following detailed description of the embodiments having reference to the attached figures, the invention not being limited to any particular embodiment disclosed.

### BRIEF DESCRIPTION OF THE DRAWINGS

The above and other aspects, features, and advantages of the present invention will become more apparent upon consideration of the following description of preferred embodiments, taken in conjunction with the accompanying drawing figures, wherein:

FIG. 1 is a block diagram showing various components of a mobile terminal in accordance with an embodiment of the present invention;

FIG. 2 depicts an interface configured with an input unit of the mobile terminal of FIG. 1;

FIG. 3 depicts an enlarged view of the interface of FIG. 2;

FIG. 4A provides an example of various regions which may be associated with corresponding regions of a touchpad;

FIG. 4B provides an alternative arrangement of regions of an interface which may be associated with corresponding regions of a touchpad;

FIGS. 5A-5E provide examples of the activation of various LEDs of an interface responsive to user contact with different regions of a touchpad;

FIGS. 6A and 61B depict an interface configured to display the current time;

FIG. 7 depict an interface configured to display an icon or image which indicates receipt of a message;

FIG. 8 depicts an interface configured to display an icon or image indicating receipt of a voice message;

FIG. 9 depicts an interface configured to indicate that wireless Internet access is activated;

FIG. 10 depicts an interface configured to indicate a visual alarm;

FIG. 11 depicts an interface configured to visually represent audio which is output via an audio output unit;

FIGS. 12A and 12B are partial side views of a touchpad and underlying structure; and

FIG. 13 is a flowchart depicting operation of a portable electronic device in accordance with an embodiment of the present invention.

### DETAILED DESCRIPTION OF THE PREFERRED EMBODIMENTS

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

Various embodiments will be described in conjunction with a mobile terminal. However, such teachings apply also to other types of electronic devices. Examples of such devices include portable electronic devices, digital broadcast receiving terminals, MP3 players, personal digital assistants (PDAs), portable multimedia players (PMPs), and the like. Moreover, various methods will be described in conjunction with regard to a mobile terminal. However, it is to be understood that embodiments of the present invention are not so limited and may alternatively be implemented using other types of electronic devices, such as those noted above.

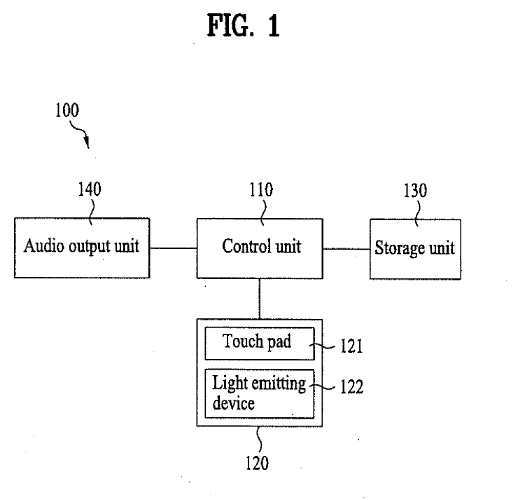

FIG. 1 is a block diagram showing various components of a mobile terminal in accordance with an embodiment of the present invention. In particular, mobile terminal 100 includes control unit 110, interface 120, storage unit 130, and audio output unit 140. It is understood that the mobile terminal includes additional components which are not illustrated in the figure, but such components are not necessary for understanding embodiments of the present invention.

Interface 120, which is one example of an input unit, is shown having touchpad 121 and one or more light emitting devices 122. The light emitting devices may be implemented using various types of devices which emit light including, for example, light emitting diodes (LEDs), semiconductor laser devices, organic electroluminescence devices, and inorganic electroluminescence devices, among others.

Touchpad 121 represents a device configured to receive direct or indirect user contact (e.g., finger, stylus, and the like). A touchpad is typically located on one side of an input area (e.g., a bottom side of a housing), and may be configured to generate signaling responsive to such user contact. In a typical embodiment, the light emitting devices are arranged under, or adjacent to, the touchpad in such a manner to emit light which is visible to the user. Light emitting devices 122, which for ease of discussion and clarity will be referred to herein as LEDs 122, may be arranged in various configurations such as, for example, a linear array or a two-dimensional array.

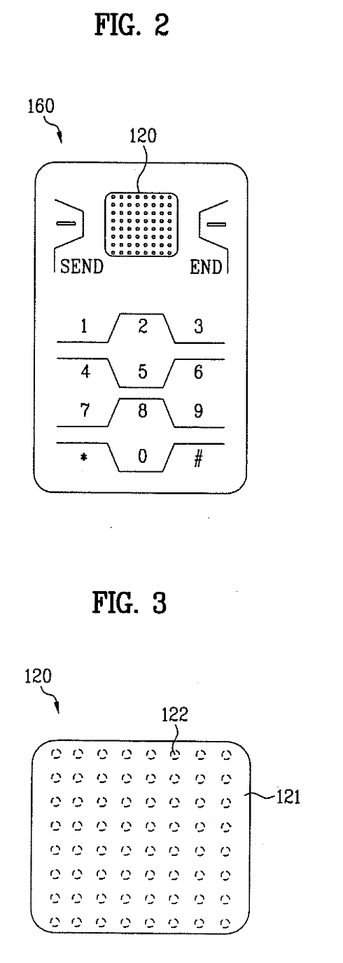

FIG. 2 depicts an interface configured with an input unit of a mobile terminal. By way of non-limiting example, interface 120 is shown centered proximate the upper end of input unit 160. The input unit may be implemented as a touch pad interface, conventional push buttons, combinations thereof, and the like. In an embodiment, interface 120 is configured as a navigation key or a navigational interface. FIG. 3 depicts an enlarged view of interface 120. In this figure, LEDs 122 are shown in more detail as being arranged in an array about the interface.

The term “navigation key” includes reference to a key which provides directional or other movement of an indicator on an associated display. If desired, one or more navigation keys may additionally or alternatively provide a selection function in which a displayed item, for example, may be selected or highlighted for selection.

The term “indicator” includes reference to a cursor, highlighting, and other techniques for positioning about a display of the mobile terminal. The indicator may include directional movement, image movement, and the like. Examples of directional movement of the indicator include upward, downward, right, left, and diagonal, among others.

Touchpad 121 may be formed using almost any material which permits user contact to be detected. Examples of materials suitable for the touchpad include transparent materials, semi-transparent materials, non-transparent materials, and the like. If non-transparent materials are utilized, one or more regions which permit light transmission at the wavelength of interest may be used to permit the transmission of light of the associated LEDs 122. An example of such an embodiment is one in which the LEDs are arranged in an 8×8 array, and the non-transparent touchpad includes transparent or semi-transparent regions arranged in an 8×8 array which cooperates with the LED array.

In an embodiment, LEDs 122 may be selectively activated based upon detection of user contact with interface 120, and in particular with touchpad 121. As an example, an initial operation may include receiving user contact at an input area. The input area may be associated with an underlying touchpad 121 having a plurality of regions. Another operation includes identifying which region of the plurality of regions is associated with the user contact. Next, light may be generated responsive to the user contact from one or more of the LEDs 122 at a location proximately located to the user contact. Typically, various components of interface 120 are controlled by a suitable processor or control unit, such as control unit 110.

If desired, the user contact may also be used to navigate, select, or both, items displayed on an associated display of the mobile terminal. It is understood that according to an embodiment, this display is separate from the input area. One benefit of this arrangement is that the LEDs may be used as an additional display to convey information or feedback to the user in a manner which augments or replaces that which is provided by the primary display of the mobile terminal.

The interface may also be configured to permit operation upon receiving sliding user contact relative to touchpad 121. In this configuration, the LEDs generate light responsive to the sliding user contact such that the LEDs are each proximately located to the received user contact. This aspect allows, for example, the swiping of a finger across the input area, which consequently results in the generation of light in a manner that traces the user's location at which the touchpad is contacted. The light from the LEDs effectively follows the user's finger as a result of the user's contact with the touchpad.

Situations will occur during which user contact with the touchpad has not occurred for a predetermined period of time (e.g., 20 seconds, 60 seconds, etc.). In such situations, the mobile terminal may enter an idle mode until additional user contact is received. In an embodiment, the idle mode may include generating light from LEDs, and then repeatedly modifying the perceived brightness of the light over a period of time. Alternatively, the idle mode may include generating light from a predetermined number of LEDs, and repeatedly modifying the number of lighted LEDs over a period of time.

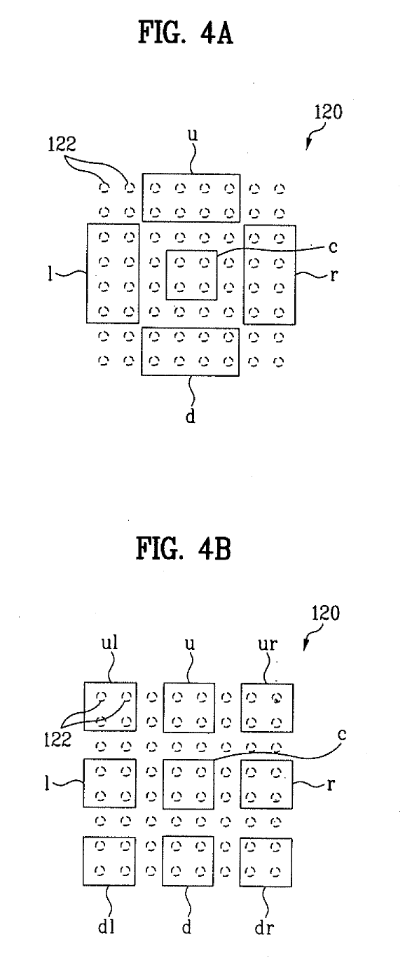

The LEDs may be arranged in assorted configurations, as required or desired. FIGS. 4A and 4B depict one such configuration. In particular, these figures show LEDs 122 arranged in an 8×8 array. FIG. 4A further provides an example of various regions which may be associated with corresponding regions of the touchpad. In particular, interface 120 of FIG. 4A is shown having five distinct regions denoted by regions U, D, L, R, C. In an embodiment, each of the regions define a key region which may be used for navigating items on an associated display. As shown, regions U, D, L, R, and C may be respectively associated with navigational functions of up, down, left, right, and select (e.g., highlight, enter, accept, and the like).

FIG. 4B illustrates an alternative arrangement of regions of interface 120, such regions also corresponding to regions of the touchpad. For instance, the interface is shown having eight distinct regions denoted by regions U, D, L, R, C, UL, UR, DL, DR. In an embodiment, each of the regions define a key region which may be used for navigating items on an associated display (via contact with the touchpad). According to the embodiment of FIG. 4B, regions U, D, L, R, C, UL, UR, DL, DR may be respectively associated with navigational functions of up, down, left, right, and select (e.g., highlight, enter, accept, and the like), up-left, up-right, down-left, and down-right. This embodiment enables diagonal navigation via contact with the touchpad at the appropriate regions.

The examples of FIGS. 4A and 4B are not to be construed as limiting, and other arrangements are possible and within the teachings of the present disclosure. Furthermore, feedback may be provided to the user by activation of LEDs 122 responsive to user contact with the touchpad. As an example, if user contact is detected in a region of the touchpad which corresponds to region U, then one or more LED associated with region U can be activated. Activation of the LEDs provides visual feedback to the user such that the mobile terminal acknowledges this contact. Alternatively or additionally, tactile feedback (e.g., vibration detectable by a user) may also be provided responsive to detection of contact, or sequence of contacts, with the touchpad.

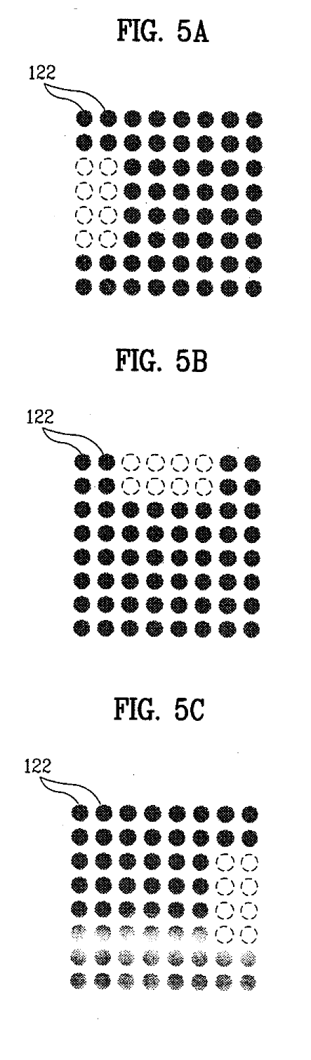

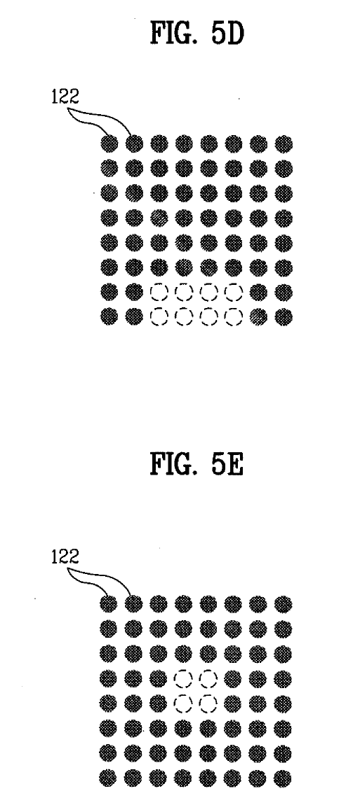

FIGS. 5A-5E provide examples of the activation of various LEDs 122 of the interface responsive to user contact with different regions of the touchpad. In each of these figures, activated LEDs 122 are shown in dashed-lines, and non-activated LEDs are shaded.

In FIG. 5A, various LEDs are activated on the left side of the interface. These LEDs are typically activated responsive to user contact with region L of the touchpad (FIG. 4A). FIGS. 5B-5D illustrate activation of LEDs responsive to user contact with the touchpad at regions U, R, D, and C, respectively (FIG. 4A).

Various operational aspects of LEDs 122 may be predefined or user selectable. Such aspects include brightness, duration, timing, and the like. For instance, the user may be permitted to select the brightness of the activated LEDs, or how long the LEDs remain activated. In addition, the user may further control the delay period between the detection of user contact with the touchpad and the activation of the LEDs,

Embodiments have been described in which assorted LEDs are activated responsive to user contact with an associated touchpad. However, the LEDs may be activated in other situations and manners in accordance with alternative embodiments of the present invention. For instance, activation of the LEDs may be responsive to an event, such that the type of event determines which LEDs are to be activated. Examples of such embodiments include utilizing the LEDs to indicate one or more of the current time, reception strength of the associated mobile terminal, incoming call, message status (e.g., receipt or non-receipt of a text message, email, voice message, multimedia message, and the like), alarm, and animations, among others.

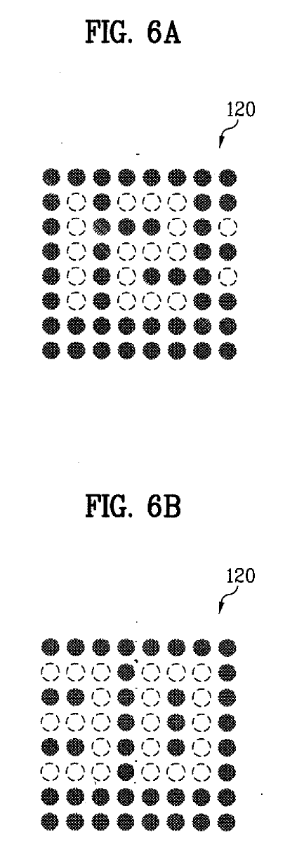

For example, FIGS. 6A and 6B depict interface 120 configured to display the current time. In particular, FIG. 6A depicts the hour “12”, and then at a later time instant, the same display may depict the minutes “30” (FIG. 6B). With sufficient numbers of LEDs, the complete time may be simultaneously displayed to avoid the need to sequentially display the hour and minutes.

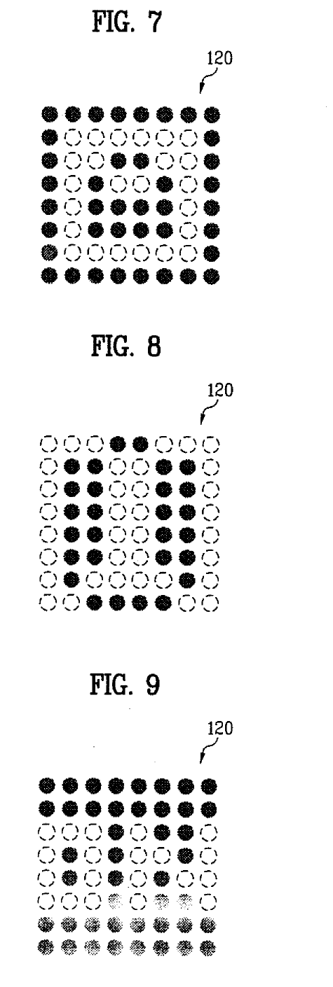

FIG. 7 depicts interface 120 configured to display an icon or image which indicates receipt of a message, such as an email or text message. Similarly, FIG. 8 depicts interface 120 configured to display an icon or image indicating receipt of a voice message. An “ON” indication may be used to indicate that wireless Internet access is activated (FIG. 9), and “!” may be used to as a visual alarm (FIG. 10). The alarm indication may be used in conjunction with, or as an alternative to, an audible alarm.

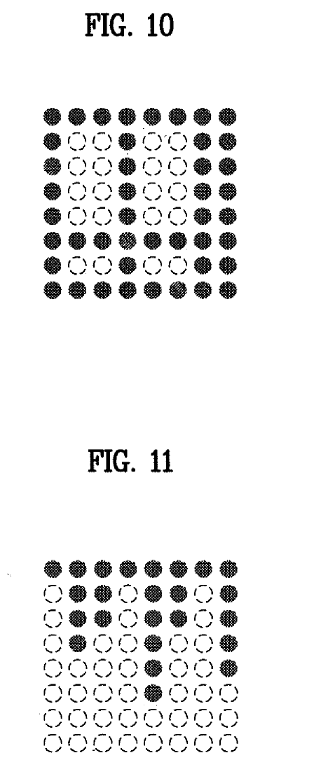

FIG. 11 depicts interface 120 configured to visually represent audio which is output via audio output unit 140 (FIG. 1). The illustrated example implements the interface as depicting the strength of the audio as a function of frequency. In particular, the horizontal axis indicates a frequency band and the vertical axis indicates signal strength. During operation, the LEDs provide real-time flickering to display an equalizer image, for example. If desired, brightness of various LEDs may also be adjusted responsive to the signal strength of the audio.

In accordance with an alternative embodiment, an icon or other image may be represented by the activated LEDs. If desired, these items may be animated according to audio being reproduced or other types of signals. Animation may also be implemented after user selection of a particular key or key.

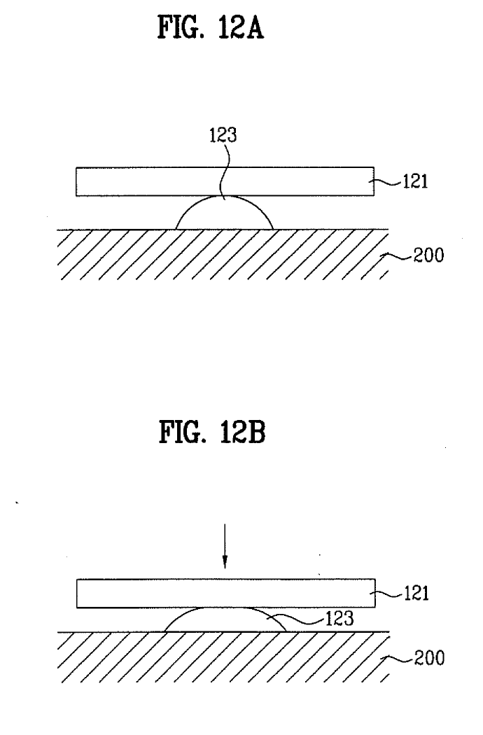

FIGS. 12A and 12B are partial side views of a typical touchpad and underlying structure. In particular, FIG. 12A depicts touchpad 121 positioned over dome switch 123, which is in contact with a supporting structure 200. In an embodiment, structure 200 includes a printed circuit board (PCB). The dome switch may be configured to fully or partially collapse responsive to user contact with the touchpad. FIG. 12B depicts the situation in which a user has contacted the touchpad with sufficient force to partially collapse the dome switch. A positive effect of using the dome switch is to provide feedback to the user.

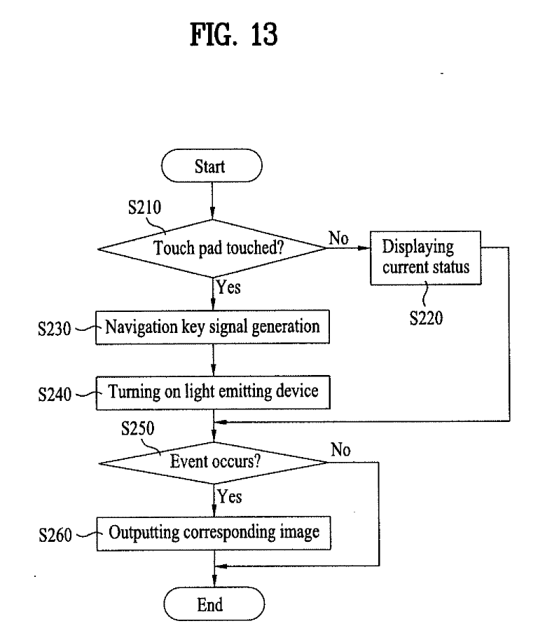

FIG. 13 is a flowchart depicting operation of a portable electronic device in accordance with an embodiment of the present invention. By way of non-limiting example only, this figure will be described with reference to the mobile terminal of FIG. 1.

Decision block S210 determines if a touchpad has been touched or otherwise contacted by a user. If no contact has been detected, then the current status may be displayed (block S220) and control flows to decision block S250. Otherwise, if contact is detected, control flows to block S230. This operation may cause control unit 110 to generate a navigating key signal corresponding to a position or location on the touchpad at which the contact is detected.

Block S240 activates the appropriate LEDs using, for example, any of the various lighting techniques described herein. According to decision block S250, if no event has occurred, then operation is terminated. Alternatively, if an event is detected, an image, icon, or animation which corresponds to the event (e.g., received email, received voice message, received call, etc.) is displayed by activating the required LEDs. In an embodiment, an application associated with the event may be executed responsive to additional user contact with the touchpad or other input device.

Although embodiments of the present invention may be implemented using the exemplary series of operations described herein, additional or fewer operations may be performed. Moreover, it is to be understood that the order of operations shown and described is merely exemplary and that no single order of operation is required.

The foregoing embodiments and advantages are merely exemplary and are not to be construed as limiting the present invention. The present teaching can be readily applied to other types of apparatuses and processes. The description of the present invention is intended to be illustrative, and not to limit the scope of the claims. Many alternatives, modifications, and variations will be apparent to those skilled in the art.

What is claimed is:

1. A method for providing light feedback responsive to user contact with an input device, the method comprising:
receiving user contact at an input area associated with a touchpad comprising a plurality of regions;
identifying which region of the plurality of regions is associated with the user contact;
navigating items displayed on an associated display, which is separate from the input area, responsive to the user contact; and
generating light responsive to the user contact from at least one light emitting device at a location proximately located to the user contact.

2. The method according to claim 1, wherein one of the plurality of regions defines a navigational direction key region, the method further comprising:
navigating the items responsive to user contact with the navigational direction key region.

3. The method according to claim 1, wherein one of the plurality of regions defines a selection key region, the method further comprising:
selecting one of the items responsive to user contact with the selection key region.

4. The method according to claim 3, further comprising:
providing tactile feedback responsive to user contact with the selection key region.

5. The method according to claim 1, further comprising:
receiving sliding user contact at the input area; and
generating light responsive to the sliding user contact from a plurality of light emitting devices which are each proximately located to the user contact, wherein the light emitting devices are arranged as a two-dimensional array within the input area.

6. The method according to claim 1, further comprising:
determining that the user contact has not occurred for a predetermined period of time;
entering an idle mode until additional user contact is received, wherein the idle mode comprises:
generating light from a light emitting device located within the input area; and
repeatedly modifying perceived brightness of the light over a period of time during the idle mode.

7. The method according to claim 1, further comprising:
determining that the user contact has not occurred for a predetermined period of time;
entering an idle mode until additional user contact is received, wherein the idle mode comprises:
generating light from a predetermined number of light emitting devices located within the input area; and
repeatedly modifying the predetermined number over a period of time during the idle mode.

8. The method according to claim 1, further comprising:
determining an occurrence of an event; and
displaying an icon representing the event using a plurality of the at least one light emitting device.

9. The display method of claim 8, further comprising:
animating the icon.

10. The method according to claim 8, wherein after the displaying, the method further comprises:
receiving additional user contact at the input area; and
causing an application associated with the event to execute responsive to the additional user contact.

11. The method according to claim 1, further comprising:
simultaneously receiving the user contact on at least two discrete locations of the input area;
identifying that the user contact corresponds to at least two regions of the plurality of regions to define a selection request; and
selecting an identified item of the items responsive to the selection request.

12. The method according to claim 11, further comprising:
providing tactile feedback responsive to the selection request.

13. The method according to claim 1, further comprising:
causing an event to occur at the mobile terminal responsive to the user contact; and
displaying an icon representing the event using a plurality of the at least one light emitting device.

14. The method according to claim 1, further comprising:
outputting audio of an audio signal; and
displaying an image corresponding to the audio signal using a plurality of the at least one light emitting device.

15. The method according to claim 14, wherein the image includes one or more of strength of the audio signal as a function of frequency, and an animated equalizer image.

16. A portable device, comprising:
an input area for receiving user contact;
a touchpad associated with the input area and comprising a plurality of regions;
a display for displaying items;
at least one light emitting device, which is separate from the display, and which is proximately located to the input area; and
a control unit for providing light feedback to a user, wherein the control unit is configured to:
identify which region of the plurality of regions of the touchpad is associated with the user contact;
navigate items displayed on the display responsive to the user contact; and
activate the light emitting device responsive to the user contact.

17. The portable device according to claim 16, wherein one of the plurality of regions defines a navigational direction key region, wherein the control unit is further configured to:
navigate the items responsive to user contact with the navigational direction key region.

18. The portable device according to claim 16, wherein one of the plurality of regions defines a selection key region, wherein the control unit is further configured to:
select one of the items responsive to user contact with the selection key region.

19. The portable device according to claim 18, further comprising:
a tactile element for providing tactile feedback responsive to user contact with the selection key region.

20. The portable device according to claim 16, further comprising:
a plurality of light emitting devices which are each proximately located to the input area, wherein the light emitting devices are arranged as a two-dimensional array within the input area, and wherein the control unit is further configured to:
selectively activate the light emitting devices which correspond to a location at which sliding user contact is received at the input area.

21. The portable device according to claim 16, wherein the control unit is further configured to:
determine that the user contact has not occurred for a predetermined period of time;
cause the portable device to enter an idle mode until additional user contact is received, wherein during the idle mode, the control unit is further configured to:
generate light from a light emitting device located within the input area; and
repeatedly modify perceived brightness of the light over a period of time during the idle mode.

22. The portable device according to claim 16, wherein the control unit is further configured to:
determine that the user contact has not occurred for a predetermined period of time;
cause the portable device to enter an idle mode until additional user contact is received, wherein during the idle mode, the control unit is further configured to:
generate light from a predetermined number of light emitting devices located within the input area; and
repeatedly modify the predetermined number over a period of time during the idle mode.

23. The portable device according to claim 16, wherein the control unit is further configured to:
determine an occurrence of an event; and
display on the display an icon representing the event using a plurality of the at least one light emitting device.

24. The portable device method of claim 23, wherein the control unit is further configured to:
animate the icon.

25. The portable device according to claim 23, wherein after the icon is displayed, the control unit is further configured to:
receive additional user contact at the input area; and
cause an application associated with the event to execute responsive to the additional user contact.

26. The portable device according to claim 16, wherein the control unit is further configured to:
simultaneously receive the user contact on at least two discrete locations of the input area;
identify that the user contact corresponds to at least two regions of the plurality of regions to define a selection request; and
select an identified item of the items responsive to the selection request.

27. The portable device according to claim 26, further comprising:
a tactile element for providing tactile feedback responsive to user contact with the selection key region.

28. The portable device according to claim 16, wherein the control unit is further configured to:
cause an event to occur at the portable device responsive to the user contact; and
display on the display an icon representing the event using a plurality of the at least one light emitting device.

29. The portable device according to claim 16, further comprising:
an audio output unit for outputting audio of an audio signal, and wherein the control unit is further configured to:
display an image corresponding to the audio signal using a plurality of the at least one light emitting device.

30. The portable device according to claim 29, wherein the image includes one or more of strength of the audio signal as a function of frequency, and an animated equalizer image.

31. A mobile terminal, comprising:
an input area for receiving user contact;
a touchpad associated with the input area and comprising a plurality of regions;
a display for displaying items;
at least one light emitting device, which is separate from the display, and which is proximately located to the input area;
a tactile element for providing tactile feedback; and
a control unit for providing light feedback to a user, wherein the control unit is configured to:
identify which region of the plurality of regions of the touchpad is associated with the user contact;
navigate items displayed on the display responsive to the user contact;
activate the light emitting device responsive to the user contact; and
activate the tactile element responsive to the user contact at a predetermined touchpad region of the plurality of regions.
